(19) United States
(12) Patent Application Publication
(10) Pub. No.: US 2012/0143445 A1
(43) Pub. Date: Jun. 7, 2012

(54) Construction machine having a mobile operating unit and mobile operation unit

(75) Inventor: Erwin Morath, Ehingen-Lauterach (DE)

(73) Assignee: LIEBHERR-WERK EHINGEN GMBH, Ehingen/Donau (DE)

(21) Appl. No.: 13/312,494

(22) Filed: Dec. 6, 2011

(30) Foreign Application Priority Data
Dec. 7, 2010 (DE) 20 2010 016 283.1

(51) Int. Cl. B66C 13/18; E02F 9/20

(52) U.S. Cl. 701/50

(57) ABSTRACT

A construction machine, in particular a crane or earthmover, comprising at least one mobile operating unit for monitoring and/or controlling the construction machine, wherein one or more transmission units are arranged at the construction machine which cooperate with the reading unit of at least one mobile operating unit, whereby a position-dependent monitoring function and/or control function of the construction machine is activated by means of the mobile operating unit.

The invention relates to a construction machine, in particular to a crane or to an earthmover, having at least one mobile operating unit for monitoring and/or controlling the construction machine.

It is known to operate a construction machine, in particular a crane, via a remote control. In accordance with DE 20 2004 008 083 U1, the crane operator with his mobile remote control must be located in a near zone to a reception unit attached to the crane. A transducer for transmitting the control commands made to the reception unit of the crane is located at the remote control. This embodiment variant is, however, only efficient if only one single reception unit is required at the crane. If a plurality of reception units are required in order, for example, to allow the signal transmission to a plurality of positions, this solution approach can result in rapidly increasing costs.

It is a requirement of the Employers' Liability Insurance Association that the crane operator has to be located at safe positions when he is performing crane operations by means of a remote control. Visual contact to the crane movement to be made or to its effective zone is thus an absolute requirement. This measure does not serve only the personal protection of the crane operator, but is likewise intended to protect non-involved third-parties from possible dangers. In known solutions, the crane operator has to confirm a location predefined by the crane manufacturer in the remote control to satisfy the named demand.

It is furthermore known from DE 10 2008 047 425 A1 to tie the performability of the crane movements by means of remote control to a specific location position of the crane operator.

It is a peculiarity of handy remote controls with a comparatively small display unit that not all controllable functions can be shown on the display unit. The use of menu trees therefore provides a remedy. The operating interface is divided into a main menu having a number of subsequent submenus to design the plurality of selection points in a more or less clear manner. The more functions have to be controlled from the remote control, however, the more submenus are required and the display can quickly become confusing for the crane operator. It is in particular difficult see which level of the menu structure the operator is currently in and how the target level can be reached as fast as possible starting from the currently available level.

It must be taken into account that the constructions machines, for example the crane, are used at different operating sites having the most varied local conditions. An adjustment of the transmitter and receiver to one another under defined spatial conditions is not possible. Different reflections are always present.

In addition, the construction machines in question here are used outdoors as a rule. Different crossfeeds are thus to be anticipated.

It is the object of the present invention to further develop the above-described solutions to eliminate the discussed problems without having to accept a prohibitive cost escalation in so doing.

This object is achieved by a construction machine in accordance with the features of claim 1. The construction machine accordingly includes at least one mobile operating unit which is suitable for monitoring and/or controlling the construction machine. In accordance with the invention, one or more transmission units are arranged at the construction machine which cooperate(s) with the reading unit of the mobile operating unit. The transmission unit fastened to the construction machine accordingly transmits a signal which can be read using the reading device of the mobile operating unit. A position-dependent activation of a corresponding monitoring function and/or control function of the construction machine which can be performed by means of the operating unit takes place in dependence on the detected signal.

The subsequent control of the construction machine with the aid of the mobile operating unit, that is, the transmission of the control command/control signal to the drive of the construction machine, can generally be performed as desired and is irrelevant in the consideration of the subject matter in accordance with the invention. The invention should only show a solution which provides a position-dependent restriction of the monitoring function or control function of the mobile operating unit.

In contrast to DE 20 2004 008 083 U1, a less cost-intensive transmission unit is to be attached to the construction machine in large numbers. The cost-intensive reading device is attached once to every mobile operating unit of the construction machine. This represents a solution of the initially presented object which is as innovative as it is cost-optimized.

The transmission unit expediently comprises at least one integrated passive transponder which transmits the corresponding signal as soon as the transponder is stimulated or irradiated by a reading device. The transponder accordingly only transmits as required to keep the energy consumption as low as possible.

Alternatively, the transmission unit can include at least one transmitting switch which emits the required signal after a corresponding switch actuation. The energy source for such a switch can be drawn from the pressure pulse on the actuation or movement of the switch. It would also be possible to power the switch by solar energy.

Different transmission units each having an integrated transponder or transmitting switch are advantageously distributed and securely fastened over the total construction machine. The fastening of the transmission units in particular takes place in a shape matched manner and can be or is releasably attached to the construction machine by means of a special tool. The releasable connection possibility allows a flexible equipping of the construction machine with transmission units, said equipping being able to be adapted to the respective demands at the operating site. Existing construction machinery can furthermore be retrofitted simply and inexpensively.

In a preferred embodiment of the invention, at least one transmission unit is attached to the undercarriage and/or to the superstructure. In the embodiment of the construction machine as a crane, an expedient fastening of at least one transmission unit to the boom system is advantageous. The transmission unit can generally be attached to any equipment articles of the construction machine. The attachment of the respective transmission unit is in relation to the respective monitoring function or control function of the construction machine to be activated. The position the crane operator has to adopt to carry out the machine function can so-to-say be restricted to the reception zone of the transmission unit. The attachment of the transmission unit to the boom system has the result, for example, that the luffing movement or the telescoping movement of a boom system can only be carried out in the corresponding reception zone of the transmission unit by means of the mobile operating unit.

It can be advantageous that at least one mobile operating unit has at least one storage means for storing data records characterizing one or more machine functions. The data records as a rule include specific information on the control components of the construction machine to be activated in the zone of the transmission unit. A data record can preferably include information on one or more machine functions. It is nevertheless possible that the storage unit of at least one transmission unit stores a plurality of data records which activate the actuation of a plurality of equipment articles of the construction machine by means of the mobile operating unit. The stored data record can be read out by the reading device of the mobile operating unit and results indirectly/directly in the activation of the monitoring functions and/or control functions associated with the data records.

It is expedient for evaluating the read-out data records that the mobile operating unit has at least one processing unit. The processing unit determines the respective characteristic machine functions from the received data record and activates the corresponding monitoring function/control function on the mobile operating unit for the defined machine function.

The mobile operating unit advantageously comprises at least one display unit which allows a clear menu presentation of the activated monitoring functions and/or control functions. It is particularly expedient in this connection that the menu structure can be presented on the display unit in dependence on the evaluation result provided by the processing unit. This in particular provides the advantage that the usually small display unit does not continuously have to display the complete menu structure which includes all the monitoring functions and/or control functions. Instead, only the monitoring functions and/or control functions activated in dependence on the position of the crane operator are shown, whereby clarity is promoted. This results in a substantial increase in the operator ergonomics of the mobile operating unit.

It can be expedient that a constant and/or regular exchange of data is required between the mobile operating unit and the transmission unit to effect a permanent function activation. An actuation of specific machine functions can be restricted to the corresponding reception zone of the transmission unit for technical safety reasons to minimize the risk potential for the operator and for uninvolved persons on the construction site as much as possible.

Alternatively, a one-time data exchange between the transmission unit and the mobile operating unit can be sufficient to activate the corresponding position-dependent monitoring function and/or control function. The activation is preferably restricted to a definable time interval. The operator must accordingly only be in the reception zone of the transmission unit once to activate the monitoring function and/or control function permanently or limited to a specific time interval. The freedom of movement of the operator is not hereby additionally restricted.

In a particularly preferred embodiment of the invention, it is specifically fixed for each transmission unit whether a constant exchange of data or a one-time exchange of data is required for the activation. Consequently, the activation specifications for any desired machine function can be specifically fixed and stored in the corresponding data record of the transmission unit. The mobile operating unit recognizes with reference to the read-out data record whether the activation is only possible in the reception zone or should apply at any desired point.

It is possible that the reception zone of the reading device of at least one mobile operating unit is limited to a radius between 5 cm and 50 cm. If a permanent data transmission between the transmission unit and the reading unit is required for the activation, an expansion of the reception radius may be expedient in order not to restrict the freedom of movement of the operator unnecessarily.

Provision can preferably be made that at least one operating unit is designed such that an optional manual activation of a monitoring function and/or control function can take place. This is in particular expedient in the event of a defect of a specific component, in particular of a transmission unit, to avoid a total failure of the mobile operating unit.

The invention is furthermore directed to a mobile operating unit for the monitoring and/or control of a construction machine. The mobile operating unit is designed in accordance with one of the above-explained embodiments. Accordingly, the mobile operating unit includes in accordance with the invention at least one reading device as well as preferably a processing unit which effects a position-dependent activation of specific monitoring functions and/or control functions in dependence on the received signals. The mobile operating unit obviously has the same advantages and properties as the above-explained construction machine so that a further explanation will be omitted at this point.

Further advantages and properties of the invention can be seen from the embodiment shown in the drawings. There are shown:

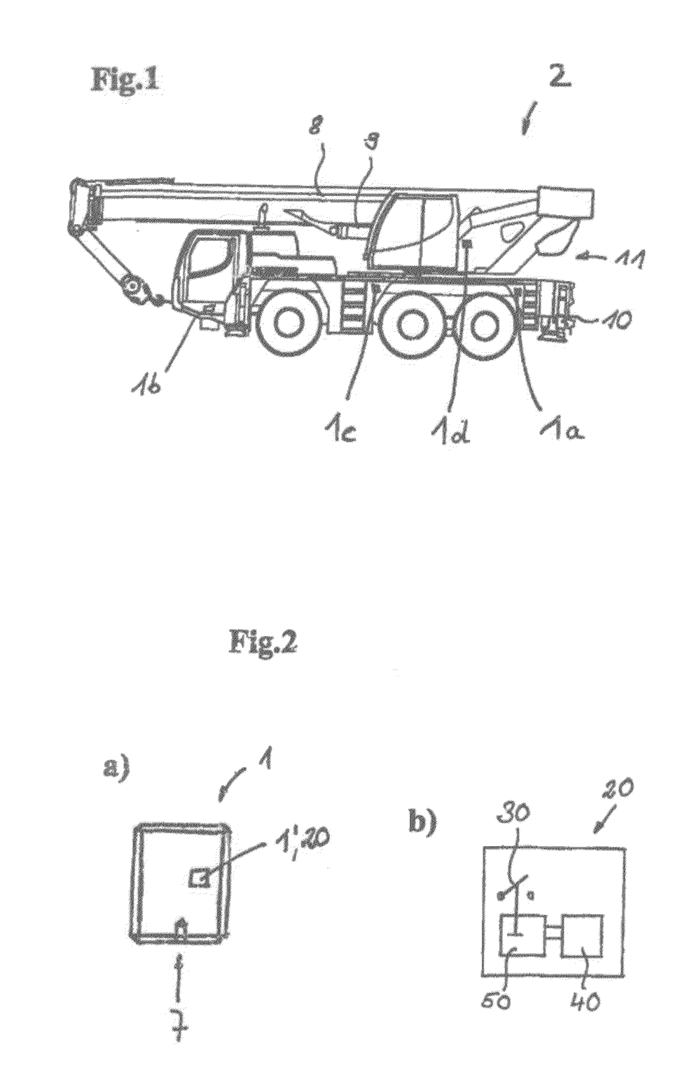

FIG. 1: a mobile crane in the transport position which is designed in accordance with the present invention;

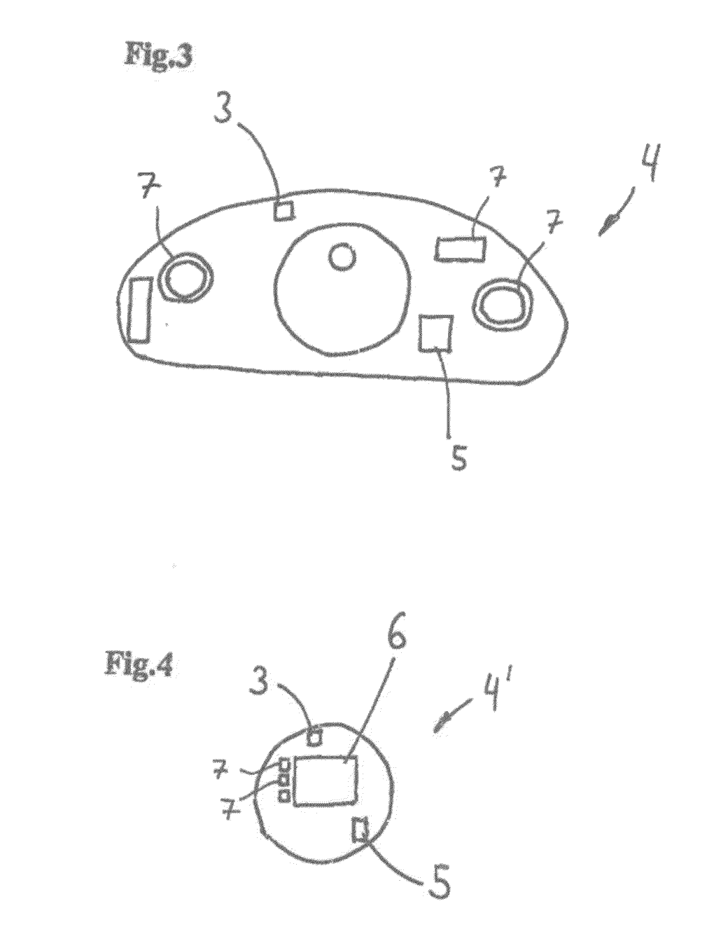

FIG. 2: a schematic representation of the transmission unit in accordance with the invention;

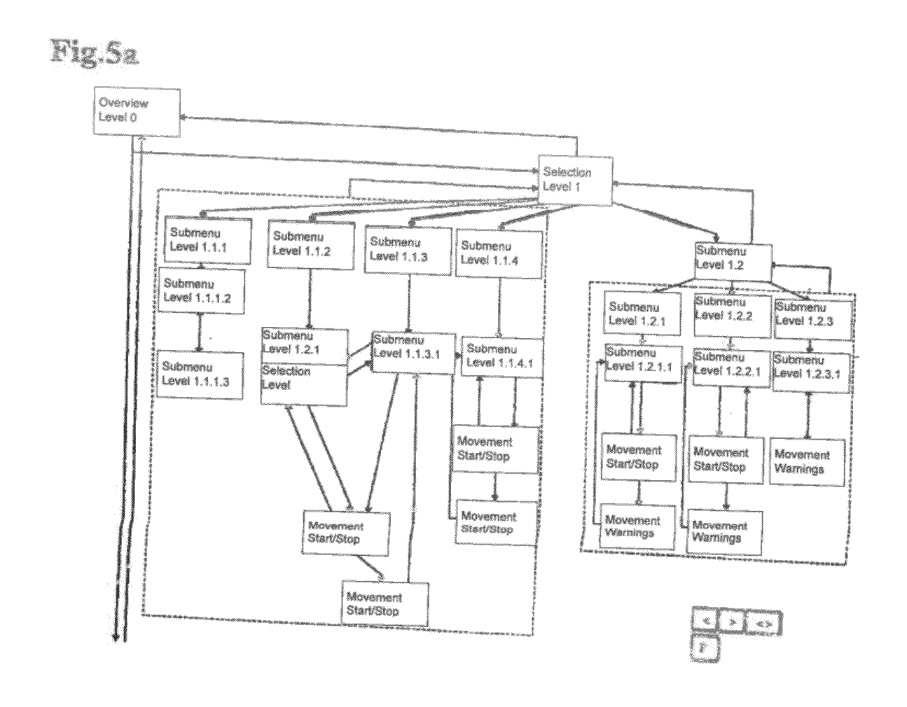

FIG. 3: a schematic representation of a mobile operating unit in accordance with the invention;

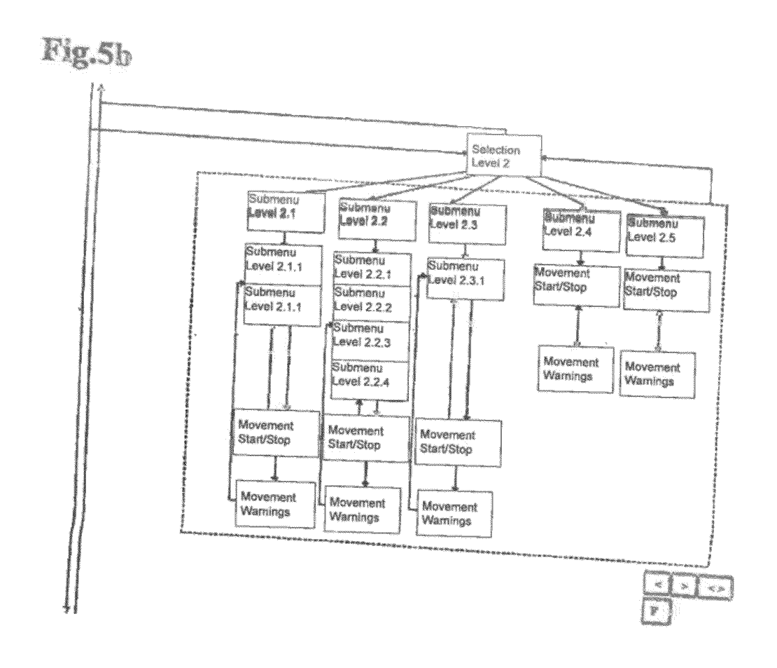

FIG. 4: a representation of a further mobile operating unit; and

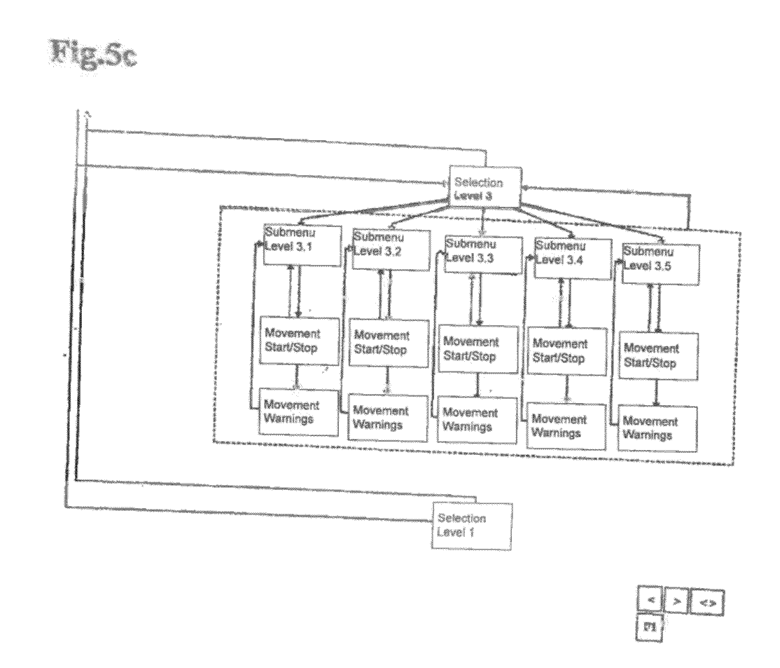

FIG. 5: an exemplary representation of a menu tree of the mobile operating unit in accordance with the invention.

FIG. 1 shows a side view of a mobile crane in accordance with the invention in a transport position. The specific embodiment of the crane is irrelevant in this respect. It must additionally be pointed out that the basic idea of the invention can generally be used in any type of construction machine.

The mobile crane 2 shown therefore has a plurality of transmission units 1 which are attached to corresponding positions to be defined at the mobile crane 2. In the embodiment shown, the two transmission units 1a, 1c are fastened to the undercarriage of the mobile crane 2, whereas the transmission unit 1d is arranged at the superstructure and the transmission unit 1b is arranged at the vehicle cabin.

A possible embodiment of the transmission unit 1 is shown schematically in FIG. 2. The transmission unit 1 of FIG. 2a, which is also called a “pill”, comprises a housing which includes an integrated passive transponder 1′. The passive transponder 1′ transmits a corresponding signal as soon as the transponder is stimulated to do so via an external device, for example by the reading device.

Alternatively, the transmission unit 1 can have a transmitting switch 20 in accordance with FIG. 2b instead of the passive transponder 1′. If the transmitting switch 20 is actuated by a force, in particular of an operator, via its switch mechanism 30, the transmission unit 40 of the switch 20 begins with the emission of the corresponding signal. The energy source 50 for such a switch 20 can be acquired from the pressure pulse on the actuation of the switch mechanism 30 or from any desired switch movement. It is also possible to feed the switch 20 by means of solar energy.

Each transmission unit 1 furthermore includes at least one storage means in which a data record is stored which characterizes a specific machine function of the mobile crane 2. The fastening of the transmission unit 1 to the crane 2 takes place in a shape-matched manner and by means of the connection possibility 7 using a special tool.

The transmission unit 1b has, for example, a relevant data record which is required for a monitoring and control of the superstructure 11 or of the boom system 8, in particular of the luffing cylinder 9. In contrast, the transmission unit 1c stores the corresponding data record which is required for activating the control function of an automatic support system 10.

In the embodiment of FIG. 1, the crane operator must adopt a defined and non-hazardous location for carrying out a specific crane movement by means of the mobile operating unit 4, 4′, which will be described in more detail below with reference to FIGS. 3, 4. For this purpose, the crane operator moves to the designated point at the crane with the mobile operating unit 4. The transmission unit 1 with the integrated transponder 1′ or the transmitting switch 20 is also attached to this point. If the operating unit 4 is located in the near region of the transmission unit 1, the reading device 3 of the operating unit 4 can read out the data record of the transmission unit 1 and forward it to the processing unit 5 of the operating unit 4.

A possible embodiment of the mobile operating unit 4 can be seen from the schematic representation of FIG. 3. The operating unit 4 includes individual operating elements 7 which are intended for inputting specific control commands. The operating unit 4 furthermore includes the processing unit 5 already mentioned above and the reading device 3 for reading out the data records of the transmission unit 1.

Since the processing unit 5 receives information with respect to the crane movement to be activated based on the received data record, specific operating elements 7 can be specifically released and even preallocated. If a plurality of crane movements should be possible from one location, the corresponding transmission unit 1 contains a plurality of data records in the storage means. The stored data records are read out by the reading device 43 of the operating unit 4 and are correspondingly interpreted by the processing unit 5 so that a plurality of different crane movements are activated.

In the embodiment, a maximum distance between the reading device 3 and the transmission unit 1 of 5 cm to a maximum of 50 cm is necessary. To keep the crane operator free in his movement, it is sufficient to transmit the data from the transmission unit 1 to the operating unit 4 once. During the carrying out of the crane movement, no constant or regular data transfer between the transmission unit 1 and the reading device 3 is necessary to maintain the activation. Provision can be made under certain circumstances that the activation can be limited to a definable time interval to activate the respective crane movement for a limited time period after the one-time reading out of the data from the transmission unit 1.

A constant and regular data transfer between the transmission unit 5 and the reading device 3 could, however, also be required technically and for a further increase of safety to effect a continuous activation of the machine function. In this case, however, a larger possible distance between the transmission unit 1 and the reading device 3 is required during the data transmission to enable ergonomic working for the crane operator.

FIG. 4 shows a further embodiment possibility of the mobile operating unit 4′ which has a visual display unit 6 with respect to the operating unit 4 of FIG. 3. The display unit 6 serves for presenting a menu structure which carries out performable monitoring functions and control functions of the mobile crane 2. The menu items can be actuable via operating means and/or via the display unit of a contact-sensitive design. The menu structure uses a menu tree which has a main menu with subordinate submenus. The other technical embodiment of the operating unit 4′ is designed analog to the operating unit 4.

Since the processing unit 5 has knowledge of the crane movement to be actuated or estimates it using the read-out data records, it can provide the required submenu to the display unit 6 immediately. A complex working through of the menu tree to the corresponding submenu which contains the monitoring function and control function activated at the location is no longer necessary. The crane operator can start the crane movement without a time delay. Switches can also have special required functions preallocated.

The same procedure takes place on the next crane movement. A laborious working back into the main menu to move from there into the desired submenu is not necessary.

If a plurality of crane movements are permitted at one location, the reading device receives a plurality of data records from the corresponding transmission unit 1 which are interpreted by the processing unit 5. In this case, the processing unit 5 controls the display unit 6 such that e.g. the most probable menu is immediately faded in. A main menu with one submenu is also conceivable. The advantage is, however, that only a small number of submenus is required and the clarity is maintained.

If no data transmission should be possible at one time in the event of a defect, the required function can nevertheless be achieved via a specific menu entry to activate the desired crane movement.

FIGS. 5a to 5c show an example for a possible menu structure which can be shown. Using the system in accordance with the invention, the display unit 6 of the operating unit 4′ e.g. immediately jumps into the submenu item 1.1.4.1 in FIG. 5a when the operating unit 4′ moves into the transmission zone of the transmission unit 1a. The menu items shown are representative for activated crane movements. If the crane operator moves to the next point with the transmission unit 1b, the display unit 6 jumps directly to the item submenu 2.2.2. The switchover of the display unit 6 to the submenu 3.1 takes place in the reception zone of the transmission unit 1c.

The crane operator consequently does not have to laboriously work through the complete menu content; instead the current activated menu for controlling or monitoring the mobile crane 2 is respectively displayed.

The present invention effects a decisive time-saving in the operation of the mobile crane 2. The position of the crane operator is furthermore fixedly defined so that there is no danger for him from the crane movement to be carried out. Furthermore, the fixed position determination for a corresponding crane operation allows the possibility of ensuring the best possible sight of the crane movement to be carried out for the crane operator. The risk potential of uninvolved persons at the construction site is hereby very largely precluded.

1. A construction machine, comprising at least one mobile operating unit for monitoring and/or controlling the construction machine,
wherein one or more transmission units are arranged at the construction machine and cooperate with a reading unit of the at least one mobile operating unit, where a position-dependent monitoring and/or control function of the construction machine is activated by the mobile operating unit.

2. A construction machine in accordance with claim 1, wherein the transmission unit includes a passive transponder and/or a supply-independent transmitting switch.

3. A construction machine in accordance with claim 1, wherein the at least one transmission unit is connected to the construction machine in a shape matched manner.

4. A construction machine in accordance with claim 1, wherein the at least one transmission unit is attached to an undercarriage and/or to a superstructure and/or to a boom and/or to further equipment articles of the construction machine.

5. A construction machine in accordance with claim 1, wherein the at least one transmission unit has storage for storing one or more data records characterizing machine functions, with the data records being readable by the at least one mobile operating unit and effecting the activation of the monitoring functions and/or control functions associated with the data records.

6. A construction machine in accordance with claim 5, wherein the at least one mobile operating unit has at least one processing unit for evaluating the received data record(s) and a menu navigation for monitoring/controlling the construction machine dependent on the evaluation result of the processing unit can be shown on at least one display unit of the operating unit.

7. A construction machine in accordance with claim 1, wherein a constant and/or regular exchange of data is necessary between the mobile operating unit and the transmission unit to effect a function activation.

8. A construction machine in accordance with claim 5, wherein a one-time exchange of data is sufficient to activate the position-dependent monitoring function and/or control function over a definable time interval.

9. A construction machine in accordance with claim 1, wherein the reception zone of the reading unit of at least one mobile operating unit is limited to a specific radius about the transmission unit.

10. A construction machine in accordance with claim 1, wherein the at least one operating unit is designed so that optionally a manual activation of the monitoring function and/or control function can take place.

11. (canceled)

12. The machine of claim 1, wherein the construction machine is a crane or an earthmover.

13. The machine of claim 1, wherein the transmission unit includes a supply-independent transmitting switch.

14. The machine of claim 1, wherein the specific radius is between 5 cm and 50 cm about the transmission unit.

15. A mobile operating unit for monitoring and controlling a construction machine, comprising:
one or more transmission units arranged at the construction machine, the transmission unit including a passive transponder or a supply-independent transmitting switch and connected to the construction machine in a shape matched manner; and
a reading unit cooperating with the one or more transmission units;
wherein a position-dependent monitoring and control function of the construction machine is activated by the mobile operating unit.

16. The unit of claim 15, wherein the at least one transmission unit is attached to an undercarriage and/or to a superstructure and/or to a boom and/or to further equipment articles of the construction machine.

17. The unit of claim 16, wherein the at least one transmission unit has storage for storing one or more data records characterizing machine functions, with the data records being readable by the at least one mobile operating unit and effecting the activation of the monitoring functions and control functions associated with the data records.

18. The unit of claim 17, wherein the at least one mobile operating unit has at least one processing unit for evaluating the received data record(s) and a menu navigation for monitoring/controlling the construction machine dependent on the evaluation result of the processing unit can be shown on at least one display unit of the operating unit.

19. The unit of claim 18, wherein an exchange of data is necessary between the mobile operating unit and the transmission unit to effect a function activation.

20. The unit of claim 19, wherein a one-time exchange of data is sufficient to activate a position-dependent monitoring function and/or control function over a definable time interval.
